(19) United States
(12) Patent Application Publication
(10) Pub. No.: US 2013/0024467 A1
(43) Pub. Date: Jan. 24, 2013

(54) DISTRIBUTED ONLINE COLLABORATION PLATFORM INCORPORATING UNSTRUCTURED AND STRUCTURED DATA

(71) Applicant: Marc Terrence Miller, Boston Heights, OH (US)

(72) Inventor: Marc Terrence Miller, Boston Heights, OH (US)

(21) Appl. No.: 13/546,951

(22) Filed: Jul. 11, 2012

Related U.S. Application Data
(60) Provisional application No. 61/506,696, filed on Jul. 12, 2011.

(51) Int. Cl. G06F 17/30

(52) U.S. Cl. 707/756; 707/E17.009

(57) ABSTRACT

Methods and systems for facilitating collaboration among a plurality of geographically dispersed participants incorporating at least one of unstructured and structured data from the participants are disclosed. The unstructured and/or structured data may be synchronized from portable and other electronic devices to an online portal and may be normalized to facilitate collaboration via the online portal by other participants as well as additional processing by other legacy business software. The electronic device may include, for example, a smart pen or a smart phone or a desktop/laptop computer. The collaboration and additional processing may include, among others, at least one of searching, analyzing, coaching, sharing, auditing, business intelligence analysis, and business process application.

### PRIORITY CLAIM

This application claims priority under 35 USC. 119(e) to a commonly-owned provisional patent application entitled “DISTRIBUTED ONLINE COLLABORATION PLATFORM INCORPORATING UNSTRUCTURED AND STRUCTURED DATA”, Application No. 61/506,696, filed by inventor Marc Terrence Miller on Jul. 12, 2011 and incorporated by reference herein.

### BACKGROUND OF THE INVENTION

Technology has made many of the more common human interactions, such as online purchases between a buyer and a merchant, filling out credit or membership applications, etc., more automated and more efficient. For relatively simple types of human interactions, structured scripts or forms tend to be the main methods for both collecting the data and for filtering the collected data into categories for further analysis or action. For a relatively simple type of human interaction, such as an online purchase session that involves a human buyer, for example, the buyer may fill in his first and last name, his address, his credit card information, and his desired purchase into a pre-defined web browser form using a combination of typed data entry and pull-down menu. The fact that the buyer enters “John” into the field “First Name” allows the online sales software both to collect an important piece of data (i.e., “John”) as well as to categorize the entered data (i.e., “John”) into a proper category (i.e., “First Name”).

The collected and categorized data may then be stored in a database for analysis and further action, including for example the consummation of the sale, the cross-selling of other products to that buyer, and/or following up with further communication regarding other products or services.

Unlike the aforementioned simple human interaction scenarios, complex human interactions have, however, remained a challenge. As the term is employed herein, complex human interactions (CHI) pertain to interactions among human participants that involve complex free-form or unstructured information, have a fairly long interaction cycle such that the interaction may span multiple sessions before the purpose of the interaction is achieved. The multiple sessions may last hours, days, weeks, months, or even years.

Complex human interactions also tend be highly collaborative in that such interactions may involve teams of direct participants and other stakeholders (i.e., those who are directly involved as well as those not directly involved but are in the supportive or interested roles). It is also important to point out that complex human interactions tend to be free-form in that they tend to involve information that is highly unstructured. Furthermore, complex human interactions often involve well-understood social rules and etiquette, and it is often impossible or highly impractical to force participants to perform data entry (e.g., enter typed information) and data categorization (e.g., pick the right field to enter the typed data) during an interaction session. Selling (as opposed to order taking) is one such example where it is impossible or impractical to stop the sales dialog to enable that field salesperson to enter data into forms for fear that the sales momentum from human interactivity may be lost.

Examples of other complex human interactions include, for example, complex sales of products or services. In technology or medical sales between two companies, for example, the sales may involve millions of dollars, and human stakeholders may include a buying team on the buyer side and a selling team on the seller side, some of whom may be directly interacting with other stakeholders (either on the same side or on the other side) but many may remain behind the scene in a supervisory or supportive role.

On the buyer side, for example, the purchase of an expensive and complex piece of equipment or a service may include the purchasing agent, the evaluating technical personnel, the budgeting personnel, the high level management, etc. On the seller side, the sales campaign may include the field sales personnel, the sales engineer, the sales manager who oversees and coaches the sales process, the product manager who ensures that the products/services are properly configured to fit the customer's needs and that products/services are available for delivery when promised, and management personnel who ensure that resources are available for carrying out the necessary manufacturing, sales, and delivery of the products or services.

An example sales process may begin with a field sales person visiting a potential buyer (person or entity) to develop a relationship and possibly create a demand. As interest develops over time, however, other stakeholders may become involved and the sales process may extend over many different sessions between different sets of stakeholders on the buying team and the selling team. These different sessions may span days, weeks, or even months before a sales transaction is consummated, if at all. Furthermore, the sale of one product or service often creates opportunities for cross-selling other products or services. If a sales team is properly trained and incentivized, that sales team can recognize and introduce these cross-selling opportunities to capture additional revenue by offering and selling other products and services.

Other examples of complex human interactions include training, collaborative product development, collaborative creative or manufacturing processes, etc. These complex human interactions are also characterized by collaboration among numerous stakeholders involving complex, free-form information exchange and a long interaction cycle.

In the following disclosure, complex sales processes are employed as examples to illustrate the features and advantages of various embodiments of the invention. It should be understood, however, that the invention is not so limiting and may apply to any type of complex human interaction.

Because of the free-form, unstructured nature of the data involved and due to the complexity of these complex human interactions (involving long time duration, soft human skills, and a large number of stakeholders involved), it is often extremely challenging to apply technology to improve productivity for complex human interactions. Although technology has been applied at the periphery of many complex human interactions (for telephonic and videoconferencing, for typing and transmitting reports, for retrieving technical documents, for displaying presentations, etc.), the overall complex sales process (representing an example of a complex human interaction) has not be systemized via computer/software technology in a way that both preserves the human nature of these delicate human interactions and offers improved productivity, access by other stakeholders, coaching, and accountability.

### SUMMARY OF THE INVENTION

The invention relates, in an embodiment, to a method for processing complex human interaction (CHI) data using at least a computer executing computer readable instructions for performing at least a portion of said processing. The method includes capturing, using a portable digital electronic device, unstructured session data pertaining to said CHI, said CHI pertaining to an interaction session between a first set of human stakeholders and a second set of human stakeholders. The method also includes annotating, using at least one of said portable digital electronic device and said computer, said unstructured session data with a set of metadata, thereby forming semi-structured data. Additionally, the method includes automatically normalizing, using said at least one of said portable digital electronic device and said computer, said semi-structured data to form normalized data, whereby said normalizing includes at least one of categorizing, sorting, automatic annotating, transcribing, concatenating, converting, and optical character recognition.

In another embodiment, the invention relates to a method for processing human sales session data using at least a computer executing computer readable instructions for performing at least a portion of said processing The method includes capturing, using a portable digital electronic device, unstructured session data pertaining to said human sales session, said human sales session pertaining to an interaction session between a first set of human stakeholders and a second set of human stakeholders. The method also includes annotating, using at least one of said portable digital electronic device and said computer, said unstructured session data with a set of metadata, thereby forming semi-structured data. The method additionally includes automatically normalizing, using said at least one of said portable digital electronic device and said computer, said semi-structured data to form normalized data, whereby said normalizing includes at least one of categorizing, sorting, automatic annotating, transcribing, concatenating, converting, and optical character recognition.

In an embodiment, the portable digital electronic device represents a smart pen for simultaneously capture hand-written data and audio data.

In an embodiment, the portable digital electronic device represents a smart phone.

In an embodiment, the portable digital electronic device represents a computer in tablet form.

In an embodiment, the annotating is performed automatically by electronic circuitry in said portable digital electronic device.

In an embodiment, the annotating employs automated handwriting analytic on said unstructured session data to derive said metadata.

In an embodiment, the annotating employs automated speech analytic on said unstructured session data to derive said metadata.

In an embodiment, the annotating is performed by one of said first set of human stakeholders via said at least one of said portable digital electronic device and said computer.

In an embodiment, the method further includes performing value-added processing on at least one of said semi-structured data and said normalized data. In an embodiment, the value-added processing includes at least one of searching, analyzing, sharing, coaching using normalized structured data, indexing, annotating using speech/text analysis software, applying methodology, and applying framework.

In an embodiment, the method further includes automatically grading, said at least one of said portable digital electronic device and said computer, said semi-structured data against a predefined set of criteria, thereby deriving a set of grades. In an embodiment, the method further includes generating, using at least said set of grades, at least one of feedback data and coaching data. In an embodiment, the method further includes electronically communicating said at least one of said feedback data and said coaching data to at least a human stakeholder in said first set of human stakeholders.

In an embodiment, the unstructured session data includes at least audio data.

In an embodiment, the unstructured session data includes at least hand-written data that is created by a human stakeholder in said first set of human stakeholders.

In another embodiment, the invention relates to apparatus for processing complex human interaction (CHI) data between a first set of human stakeholders and a second set of human stakeholders. The apparatus includes at least at least a database for storing at least unstructured session data pertaining to said CHI, said CHI pertaining to an interaction session between said first set of human stakeholders and said second set of human stakeholders. The apparatus also includes at least a computer executing computer readable instructions for performing at least automatically annotating said unstructured session data with a set of metadata, thereby forming semi-structured data and automatically normalizing said semi-structured data to form normalized data, whereby said normalizing includes at least one of categorizing, sorting, automatic annotating, transcribing, concatenating, converting, and optical character recognition.

In an embodiment, the unstructured session data represents data uploaded from a smart phone.

In an embodiment, the unstructured session data represents data uploaded from a computer in tablet form.

In an embodiment, the annotating includes automated handwriting analytic on said unstructured session data to derive said metadata.

In an embodiment, the annotating includes automated speech analytic on said unstructured session data to derive said metadata.

In an embodiment, the computer further includes computer readable instructions for performing value-added processing on at least one of said semi-structured data and said normalized data.

In an embodiment, the value-added processing includes at least one of searching, analyzing, sharing, coaching using normalized structured data, indexing, annotating using speech/text analysis software, applying methodology, and applying framework.

In an embodiment, the computer further includes computer readable instruction for automatically grading said semi-structured data against a predefined set of criteria, thereby deriving a set of grades.

In an embodiment, the computer further includes computer readable instruction for generating, using at least said set of grades, at least one of feedback data and coaching data.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with an embodiment of the invention, an overall conceptual diagram of the complex human interaction data management system (CHI-DMS).

FIG. 2 shows, in accordance with an embodiment of the invention, a more detailed flowchart for generating semi-structured data from the raw recording (written and/or oral) of the sales session interaction.

FIG. 3 shows, in accordance with an embodiment of the invention, the processes for turning the semi-structured data of FIG. 2 into normalized structured data and/or the value-add data.

FIG. 4 shows, in accordance with an embodiment of the invention, some examples of auto-coaching utilizing the normalized structured data and/or value-added data.

FIGS. 5 and 6 are examples, in accordance with embodiments of the invention, of categories and sub-categories employed to process the raw recorded data.

FIG. 7 shows, in accordance with an embodiment of the invention, some example metadata for pre-call and post-call.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a, dedicated computing device when appropriately programmed and may include a combination of a computer/computing device and dedicated/programmable circuits adapted for the various tasks pertaining to embodiments of the invention.

Current complex sales processes suffer from many poor practices and inefficiencies. It is a given that from a human relationship standpoint, complex sales is a highly personal and human-interactive endeavor. In other words, complex high-dollar transactions invariably require human personal involvement, and almost always involve delicate, extensive discussions and negotiations among human participants, most of which is oral or even face-to-face. Because of the oral nature of these interactions, it is critical to capture and preserve as much information as possible. Yet salespeople know from experience that potential customers often clam up when a traditional voice or video recorder is placed on the table in the meeting. Even if a potential customer agrees to the recording, most salespeople and/or other stakeholders are highly unlikely to listen to hours of recordings made over numerous visits. Accordingly, the current practice often involves salespeople attempting to write or recreate the gist of the meetings afterward by dictating or writing reports.

However, the after-the-fact construction of the sales session is often subject to bias, poor memory, or lack of appreciation for subtle indications of interest, concern, or potential opportunities. Further, the process is highly subjective since different salespeople may have different abilities with respect to cognition or general human intelligence, and these differences are reflected in the after-session summaries. In other words, when presented with a given opportunity, the after-action report by one field salesperson may differ completely from the after-action report by another field salesperson due to the different interpretations, different levels of recall, cognitive ability, intelligence, writing ability, etc.

The inaccurate capturing of information also affects sales and manufacturing forecast accuracy, as well as bias the data entered into other business systems, such as CRM (Customer Relationship Management) databases, leading CRM teams to derive erroneous conclusions about the current and future intentions of customers. Still further, the inaccurate or incomplete capture of unstructured information renders it nearly impossible to generate accurate and objective sales process reports to management to facilitate actionable intelligence.

Further, as technology and business models progress, it's very difficult for a few salespeople to fully appreciate all the technical, business, and legal nuances. Without a firm command of these issues, missteps are often made and opportunities may be lost.

Current complex sales processes also suffer from inefficient use of coaching resources. Field coaching by an experienced sales manager is often cited as the best way to improve the productivity of a sales team. Yet, because of their high level of sales expertise, there are necessarily few experienced sales manager for a large number of sales team in every organization, and it is impractical and/or unduly expensive for a sales manager to always be present with every sales call by every sales team given the fact that numerous sales calls spanning months or years may be required before a sales is consummated, if at all. If the sales manager accompanies the sales team on only certain visits but not other visits, opportunities may be lost since cross-selling or closing opportunities may be quite random and may arise in any of the visits by the sales team, for example.

The lack of accurate data capture also impedes sales call auditing for accountability and for enforcement of sales processes and business processes. Organizations typically invest much resource and money to develop sales processes and business processes to attempt to improve sales capture and to improve sales productivity in general. Yet without the ability to be present at every sales call, management has very little ability to monitor or audit to hold sales teams accountable unless management is willing to listen to hours upon hours of recording, a task that is impractical in the real-world. Likewise, product and marketing managers do not have access to actual sales session interaction information in order to accurately receive feedback about products or marketing campaigns to revise or improve their portion of the contribution to the sales process.

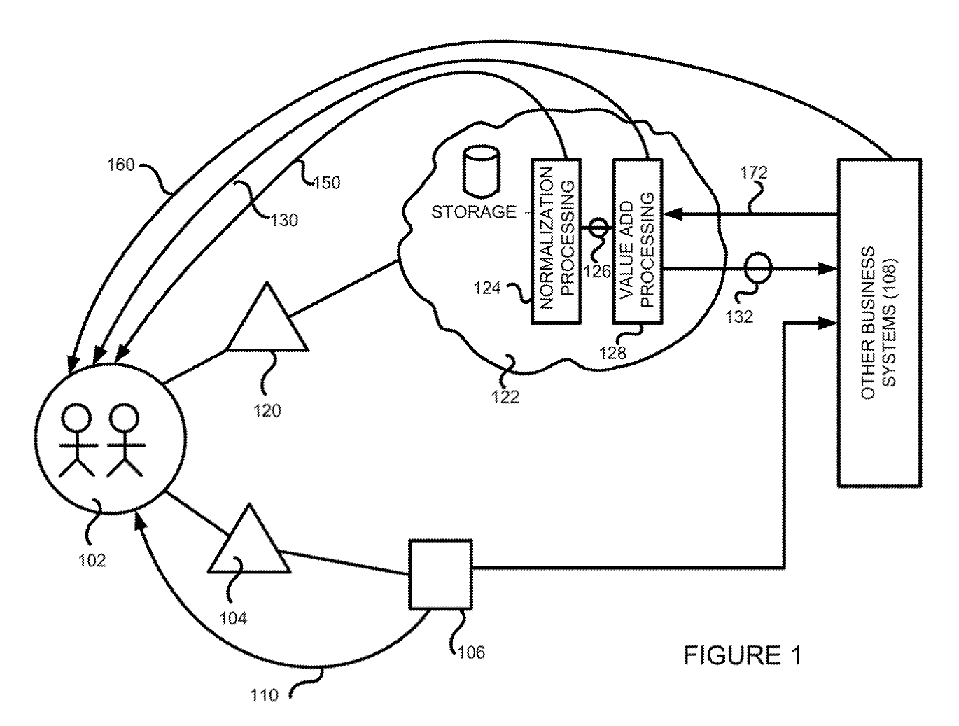

FIG. 1 shows, in accordance with an embodiment of the invention, an overall conceptual diagram of the complex human interaction data management system (CHI-DMS). In the example of FIG. 1, a complex sales process is employed to illustrate the features and benefits of an embodiment of the invention. It should be understood, however, that the invention is not so limiting and may be applied to any complex human interaction scenario. With reference to FIG. 1, there are shown a plurality of stakeholders 102, representing for example the sales team member, the sales engineers, the sales managers, the sales analysts, the sales executives, the marketing personnel, the product personnel, etc.

During a sales call, one or more stakeholders 102 may be present and may capture structured data 104 using traditional digital data capture tools. These structured data capture tools may include, for example, a prospecting form having predefined fields for the customer to fill out, a survey that directly records the customer's responses to specific questions, etc. This structured data is well-defined and may be recorded into well-defined fields of the structured data capture tools to facilitate inputting into a suitable database and/or existing data systems 106.

The structured data may then be provided to other business systems 108 such as one or more of CRM software/hardware, business intelligence software/hardware, sales productivity software/hardware, ERP (Enterprise Resource Planning) software/hardware, document management software/hardware, messaging and collaboration software/hardware, media and marketing software/hardware, and the like.

Because the structured data tends to be concise, factual, objective, and more often than not first hand information directly from the customer, this information can be readily collected, stored in a database, analyzed, processed and provided to stakeholders 102 (shown via arrow 110) for use.

However, sales processes, and more specifically complex sales processes, inherently involve delicate human interactions, most of which tend to be unstructured, free-form, and oral. For example, the process of getting introduced the right person in the buyer's organization, of establishing credibility, of exploring customer needs, of creating demand, of configuring a complex product/service to fit the customer's exact requirements, of negotiating terms for price and delivery and support, etc., all require extensive personal human involvement in unstructured, free-form meetings where data exchange tends to be primarily oral.

In one or more embodiments, the unstructured sales session data (written and/or oral) is recorded or captured verbatim and transmitted to a CHI portal for processing. The raw capture may be made using a portable electronic device, such as a smart pen (such as a smart pen available from LiveScribe, Inc. of Oakland, Calif. or at www.livescribe.com). The smart pen is a device that is capable of writing and recording simultaneously, and can link audio recording to what is written on a special type of paper. By tapping on words or drawings or predefined symbols on the special paper, the smart pen may play the recorded audio that is linked to what was written. Tapping on other symbols causes the smart pen to execute other functions, for example the functions associated with a typical digital recorder such as start, stop, rewind, forward, etc. The notes and audio recordings can be transferred to a computer for backup, replay, or sharing online.

Other electronic devices that may be employed for the raw capture of unstructured sales session data may include for example, a smart phone, a tablet computer, a portable or laptop computer, a desktop computer, or the like. Generally speaking, any electronic device that is capable of recording verbatim the written and/or oral and/or visual sales session interaction may be employed. Using these electronic devices, telephone conversations, face-to-face conversations, written notes jotted during the sales call meeting, videos of the sales call meeting, written notes jotted down after the sales meeting, voice recorded impressions of the sales meeting, etc. may be preserved. However, as will be discussed later herein, additional processing, methodology, and framework are applied to provide structure for the raw recorded data from the sales session and to render the sales session information (or relevant portions thereof) more accessible to the stakeholders in a user-friendly manner.

Pre-processing and post-processing may be applied to the recorded unstructured sales session data, either by the portable electronic device or another device (such as a smart phone, a laptop or desktop computer) that performs the pre/post processing on behalf of the portable electronic device. The pre/post processing may be performed before or during or after the sales session, or in preparation for transmission to the Complex. Human Interaction (CHI) portal, in order to turn the recorded unstructured sales session data into semi-structured data 120.

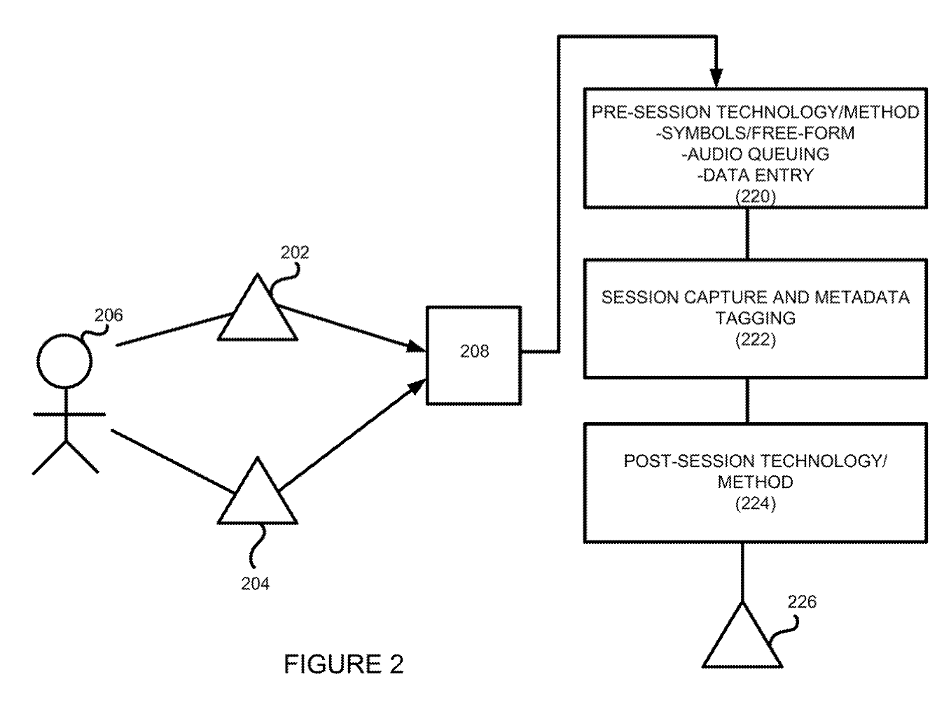

As will be discussed in connection with FIGS. 2, semi-structured data 120 includes not only the raw unstructured sales session data but also pre-session metadata, session metadata, and post-session metadata. Generally speaking, metadata refers to data that describes other data. For example, the field sales person may use symbols, keywords, key phrases, key gestures or other indications in order to draw attention to a particular section of the recorded raw unstructured sales session data and optionally to assign a meaning to such particular section of the raw unstructured sales session data.

In one or more embodiments, the metadata (if any) generated by the field sales person may also be supplemented by speech analytics or handwriting or text analytics software to automatically generate metadata from the raw unstructured sales session data and to tag or annotate certain sections of the raw unstructured sales session data with the automatically generated metadata to facilitate the structuralization of the raw unstructured sales session data for archival, analysis, or subsequent use by external business systems as well as for access by other stakeholders.

In one or more embodiments, speech analytics or handwriting or text analytics software may also automatically categorize portions of a discussion or notes, which categorization may be used to annotate the written notes with one or more visual annotations (which may, for example, be visual symbols or textual blocks) so that the written notes and/or audio recordings are in effect “pre-digested” or “pre-categorized” for ease of use by other stakeholders. For example, if the customer happens to discuss the requirement for shipment, the speech analytics or handwriting or text analytics software may automatically categorize that portion of the audio recording and/or notes with the predefined “customer shipping requirement” categorization and automatically annotate the specific page of note or a specific phrase or symbol of the handwritten note or a specific location of the page of the note with a visual annotation denoting “customer shipment requirement.” In one or more embodiments, if a stakeholder selects the visual annotation “customer shipment requirement,” the audio recording portion pertaining to the customer's discussion of shipping requirements may, for example, be replayed for review purposes.

Pre-session metadata refers to data that is connected with the recorded unstructured sales session data file but is made prior to or as preparation for the sales session. Session metadata refers to symbols, keywords, key phrases, key gestures or other indications input by the user (such as the field sales person or other personnel during the sales session) to annotate the raw recording of the unstructured sales session data while the sales session occurs. Post-session metadata refers to metadata that is connected with the recorded unstructured sales session data file but is made after the sales session has concluded. Post-session metadata may include the impression of the sales session just completed, action items to follow-up, etc. These various types of metadata will be discussed later in connection with FIG. 2 herein.

The semi-structured data (which comprises the recorded unstructured sales session data annotated with the metadata) is then transmitted to CHI portal 122 for normalization processing 124, which turns the semi-structured data into normalized structured data 126. CHI portal 122 may include data storage as shown. Normalization processing 124 may include, for example, categorizing, sorting, annotating using speech analytics or written language analysis, transcribing, database populating, concatenating, converting, OCR, format transformation, etc.

The semi-structured data 120 and/or normalized structured data produced by normalization processing 124 may, in one embodiment, be provided to the stakeholders for use (via arrow 130). Note that at this stage, the raw unstructured sales session data has been tagged or annotated with metadata (by the sales session participant and/or by other human beings adding the metadata after the fact and/or by speech/text analytics software). Relevant portions of the recorded unstructured sales session data may thus be easily accessed by other stakeholders (by selecting and/or or filtering or clicking on the metadata or a graphical representation of that portion, for example) since individual portions have been annotated or tagged with metadata. Indexing of the metadata also allows rapid search and retrieval of relevant associated portions, for example.

Note that the information (in the form of normalized structured data) provided via arrow 130 from normalization processing 124 represents first-hand data (since it includes the raw recorded unstructured sales session data that captures the sales session interaction) that is objective, concise and meaningful (since only the relevant portions of the raw recorded unstructured sales session data that are associated with selected metadata are provided if the one of stakeholders 102 selects those portions or metadata associated therewith).

On the other hand, the prior art method of generating after-action summaries or reports by the field sales people involves less reliable second-hand data (since the sales session interaction is filtered and possibly attenuated by memory, bias, cognitive ability, etc). Even if the field sales people of the prior art makes an audio or video recording of the entire sales session and uploads for sharing, it is impractical for other stakeholders to manually sift through hours of recording to make use of the sales interaction information. Also, the raw sales session recording of the prior art cannot be efficiently leveraged by other stakeholders and/or by existing business systems (such as CRM or BI systems).

The semi-structured data and/or the normalized structured data may also be further processed using value-add processing 128. Value-add processing 128 may utilize searching, analyzing, sharing, indexing, coaching, applying methodology, applying framework, sales productivity, sales analysis, etc. The result of value-added processing 128 is value-added data 132, which may also be furnished to the stakeholders 102 via arrow 150. Again, since the value-added data is derived from first-hand, complete, and objective data (i.e., the processed recorded sales session data), the value-added data may be more effectively employed by stakeholders 102 to further the sales objectives.

The semi-structured data and/or the normalized structured data and/or the value-add data may be provided to other business systems 108 for further processing. These existing business systems, as discussed earlier, may include CRM systems, BI systems, ERP systems, etc.

Furthermore, value-add processing 128 may obtain information from other business systems 108 (thus rendering other business systems 108 essentially a data source) to provide information to stakeholders. For example, value-add processing may obtain from a call center voice recording system (an example of other business system 108) a voice recording (for example, a complaint from a potential buyer or a customer or from another person) and may process that voice recording prior to providing the processed data from the voice recording as feedback data to stakeholders 102.

FIG. 1 also shows arrow 160, representing information provided to stakeholders 102 from other business systems 108. Although these other business systems 108 exist in the prior art and have been able to employ structured data to provide business system-generated information to the stakeholders for analysis and action, the fact that the prior art sales call process produces incomplete, biased and subjective structured data (such as forms filled out by the sales team after the sales session is completed) skews the information and recommendations provided by these existing business systems.

In one or more embodiments of the present invention, the use of semi-structured data 120 and/or the normalized structured data 126 and/or the value-add data 132, all of which are derived directly or indirectly from the recorded unstructured sales session data, allows other business systems 108 to generate decisions, recommendations, reports, etc. using objective information obtained from unstructured data in a manner that's previously not possible in the prior art. If desired, other business systems 108 may also incorporate the use of structured information 104 together with the aforementioned semi-structured data 120 and/or the normalized structured data 126 and/or the value-add data 132 to generate decisions, recommendations, reports, etc., using both, in a manner that was not possible in the prior art, structured information 104 and information (120 and/or 126 and/or 132) that is derived from recordings of unstructured sales session interaction.

FIG. 2 shows, in accordance with an embodiment of the invention, a more detailed flowchart for generating semi-structured data from the raw recording (written and/or oral) of the sales session interaction. With reference to FIG. 2, oral data (202) and/or written data (204) is recorded by stakeholder 206 (such as by one or more members of the sales team during the sales session). In an embodiment, the recording is performed by a smart pen to allow the oral information to be indexed with the written notes. Alternatively or additionally, more than one data stream may be generated. For example, one data stream may pertain to the oral information while another data stream may pertain to the written information while yet another data stream may pertain to recorded video data. Different data recording streams may be performed by different devices and/or different people in the sales team, for example. If desired, these different data recording streams may be synchronized (using for example the starting time or other synchronization cues) to permit the various data streams to be correlated to more faithfully reconstruct the sales session interaction.

Block 208 represents the various electronic devices that may be employed to record and/or process the sales session interaction. These digital capture/processing devices may include the aforementioned smart pen or variations thereof, a smart phone, a laptop computer, a desktop computer, a video recorder, an audio recorder, other digital recording or data processing devices, etc.

Prior to recording the actual sales session interaction, pre-processing methodologies may be applied to tag or annotate the recording stream with pre-session metadata (220). As mentioned, pre-session metadata refers to data that is connected with the recording file of the sales session but is made prior to or as preparation for the actual sales session and may include the identity of the prospect, the setting, the time, the location, the goal of the meeting, etc. The pre-session metadata may be generated by, for example, any stakeholder, including one or more members of the sales team. The recording may employ, for example, audio recording, typing, etc. utilizing one or more of the aforementioned digital capture/processing devices 208.

The pre-session metadata may be generated by multiple methods, at least three of which are show in block 220 of FIG. 2. A sales team member can sketch a free-form drawing, symbol, word, series of words in order to signify that the information being recorded is pre-session metadata. Alternatively or additionally, pre-session metadata may be recorded response to an audio cue (e.g., by recording the pre-session metadata after being prompted to do so). Alternatively or additionally, pre-session metadata may be recorded by typed data entry.

During the sales session, the sales session interaction is recorded (222). Session metadata refers to symbols, keywords, key phrases, key gestures or other indications input by a stakeholder (such as one or more sales team members) to annotate the raw recording while the sales session occurs. In an example, specific symbols may be drawn by the user of the smart pen to denote that the discussion currently pertains to customer needs or customer budget. Other symbols may be employed to signify other attributes of the discussion. In another example, a key phrase uttered by the sales person may denote that the current discussion pertains to customer concerns or technical feature discussion. The key phrase may later be discovered by speech analytics software to tag the relevant portion of the recorded unstructured sales session data file, for example.

Post-session metadata (224) refers to data that is connected with the recording file of the sales session but is made after the sales session has concluded. Post-session metadata may include the impression of the sales session just completed, action items to follow-up, etc. Post-session metadata may be recorded using similar techniques to those employed to create the pre-session metadata, in one or more embodiments.

Additional metadata may also be added by the recording electronic device, such as GPS location, time, etc. However, the metadata generated at this stage tends to be content-independent metadata (i.e., metadata generated without regard to the actual content of the recorded data) and participant-generated metadata (such as metadata generated by the sales team). In one or more embodiments, it is not necessary to generate each or all of the pre-session metadata, session metadata, post-session metadata. While the presence of all three types of metadata (as well as machine-generated content-independent metadata) improves data granularity, in some embodiments, the pre-session metadata may be omitted or the machine-generated content-independent metadata or the post-session metadata may be omitted, if desired. It is desirable to generate session metadata, however, to optimize subsequent processing.

The result is semi-structured data (226) generated from a combination of pre-session metadata, session metadata, and/or post-session metadata (and optionally automatically generated metadata). The semi-structured data may then synchronized from the data capture/processing devices to the CHI portal via the internet using any combination of wired or wireless/cellular technologies.

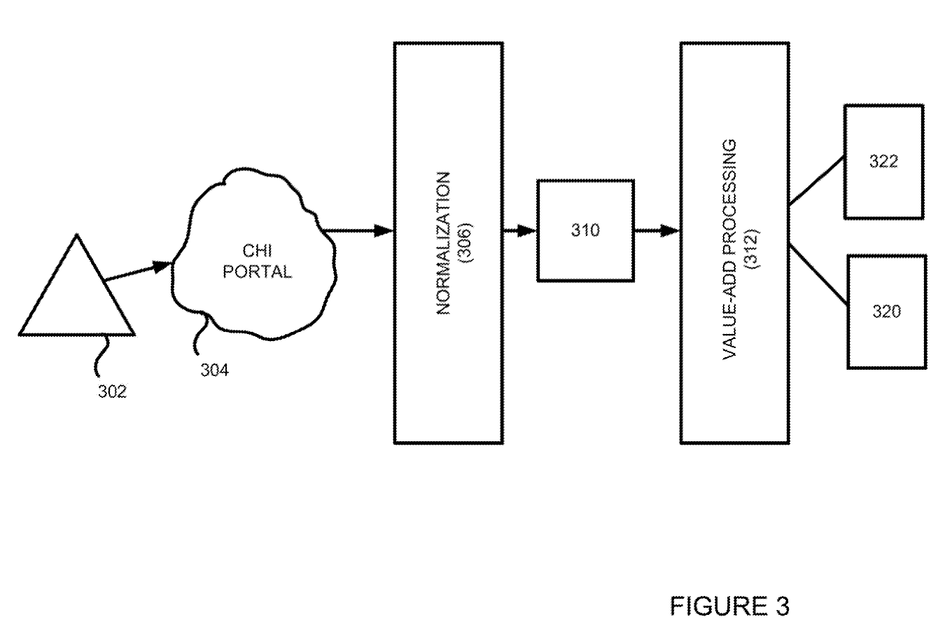

FIG. 3 shows, in accordance with an embodiment of the invention, the processes for turning the semi-structured data of FIG. 2 into normalized structured data and/or the value-add data. After the semi-structured data 302 is transmitted to the CHI portal 304 via the internet, the semi-structured data 302 may be processed using for example one or more servers. The normalization processing 306 at this stage involves normalizing the semi-structured data and may include at least one or more of categorizing, sorting, automatic annotating, transcribing, concatenating, converting, and OCR.

Categorization may employ the metadata to categorize the type of sales call, the sales call's relevance to the sales process, whether the sales call relates to field sales or data presentation, etc . . . Sorting may include taking the categorized semi-structured data and sort according to one or more criteria based on the metadata. Annotation may be automatic using speech/text analytics software and/or may be done manually to add additional metadata to specific portions of the semi-structured data. Transcribing turns the recording of oral information into textual information and optionally categorizing the written information obtained from the oral recording. Concatenation involves taking different files (audio, video, images, text, etc.) and creates a composite or unified file. Files may also be divided into logical chunks based on their metadata tags for processing and storage. Conversion involves format transformation to facilitate transmission, storage, or use by an external business system, for example. OCR involves processing a document with optical character recognition hardware/software to turn for example handwritten text or image of text into actual textual data. The result is normalized structured data 310

The semi-structured data and/or the normalized structured data may also be further processed using value-add processing 312. Value-add processing 312 may utilize searching, analyzing, sharing, coaching using normalized structured data, indexing, annotating using speech/text analysis software, applying methodology, applying framework, etc. Searching relates to the provision and use of a search facility to search through the metadata, the recorded unstructured sales session data, the semi-structured data, then normalized structured data, and/or the value-added data or portions thereof. Analyzing relates to the provision and use of an analysis facility to analyze and present results pertaining to the metadata, the recorded unstructured sales session data, the semi-structured data, then normalized structured data, and/or the value-added data or portions thereof.

Sharing relates to the provision and use of a collaboration and/or emailing and/or sharing facility to share structured and unstructured sales session data among stakeholders. Coaching pertains to the use of software to perform field coaching of sales team based on the information obtained from reviewing the metadata, the recorded unstructured sales session data, the semi-structured data, then normalized structured data, and/or the value-added data or portions thereof, or archived copies of metadata/data from previous sales sessions. Indexing relates to the provision and use of an indexing facility to analyze and index the metadata, the recorded unstructured sales session data, the semi-structured data, then normalized structured data, and/or the value-added data or portions thereof.

For example, the normalized structured data 310 may have framework applied so that the normalized structured data may be passed to stakeholders 320 (such as a sales manager for coaching purposes) or to external business system 322. The output or result of value-added processing 312 is the value-added data (such as feedback to the sales team, coaching-related data for use by the sales managers, sales analysis data for judging the effectiveness of the interaction by sales management personnel, productivity data for analysis by product managers, etc.), which may also be furnished to the stakeholders 320 and/or to external business system 322. Again, since the value-added data is derived from first-hand, complete, and objective data, value-added data may be more effectively employed by stakeholders to further the sales objectives.

Sales analysis involves examining the interaction and factors surrounding the sales session and determining whether there are factors that may sabotage the sales prospect or factors that may improve the prospect of consummating the sales going forward. The sales analysis data may be provided to a CRM business system, for example, in order to improve customer relationship management with the potential customer or may be provided to other stakeholders for action or learning, for example. Sales productivity may, for example, involve examining the sales interaction to determine whether the field sales team is effective and/or whether they adhere to the established sales methodology. The information from sales productivity analysis may then be provided to the business system or to the stakeholders, for example.

An important aspect of turning unstructured sales session recordings into concise, actionable data involves the concept of grading the portions of the raw recording that have been tagged with metadata against predefined grading criteria. This approach involves breaking the stream of raw recording into logical chunks, each of which may correlate with a metadata. The logical chunks may be delineated using time (e.g., the logical chunk may span some predefined or user-definable time window around the moment the metadata is assigned) or by using adjacent metadata tags as delineators (e.g., the logical chunk may span from the time the previous metadata is assigned through the selected metadata to the time the next metadata is assigned) or by logical analysis using speech/text analytics software or by any other approach.

For example, a metadata may relate to customer need discovery, and the portion of the unstructured sales session recording corresponding to that metadata may be analyzed, using a human or speech/text analytics software, against a predefined checklist or criteria list for customer need discovery to ascertain, for example, whether the customer need discovery was performed at the right time in the sales cycle, whether the field sales person asked certain questions, how the sales person conducted the discovery process, etc. The grade assigned may be one of Pass/Fail or may be a numerical grade (e.g., 35 out of 100) or alphanumeric (e.g., A, B, C, D, etc.).

By grading relevant portions of the interaction against predefined criteria and obtaining grades for those interaction portions, it is possible to provide useful concise information (in the form of criteria employed to grade and the grades obtained) for use by the sales team to improve their own sales process, by the sales manager to facilitate coaching, by other stakeholders to provide support and/or guidance to the sales team, and/or by other business systems in order to facilitate further processing.

This is one key advantage of one or more embodiments of the invention as it reduces or eliminates the need for a stakeholder to listen (or view) the entire recording of the unstructured sales session data file to obtain the portion that he needs for auditing, coaching, analysis, support, etc. Further, by utilizing the grades assigned, it may be unnecessary for the stakeholder to even listen or review the portion of the raw recorded data associated with the grade given. However, if the stakeholder wishes to drill down and review the underlying raw recorded unstructured sales session data portion, a hyperlink may be provided, for example, to allow the stakeholder to access the underlying raw unstructured sales session data portion associated with the grade given.

In one or more embodiments, value-added processing may analyze the raw recording and/or semi-structured data and/or normalized structured data from a plurality of stakeholders in order to uncover patterns in speech or behavior and to generate additional data for feedback to the stakeholders or for use by other business systems 108. Alternatively or additionally, value-added processing may, in one or more embodiments, analyze the raw recording and/or semi-structured data and/or normalized structured data spanning different time intervals or different sessions in order to uncover patterns in speech or behavior and to generate additional data for feedback to the stakeholders or for use by other business systems 108.

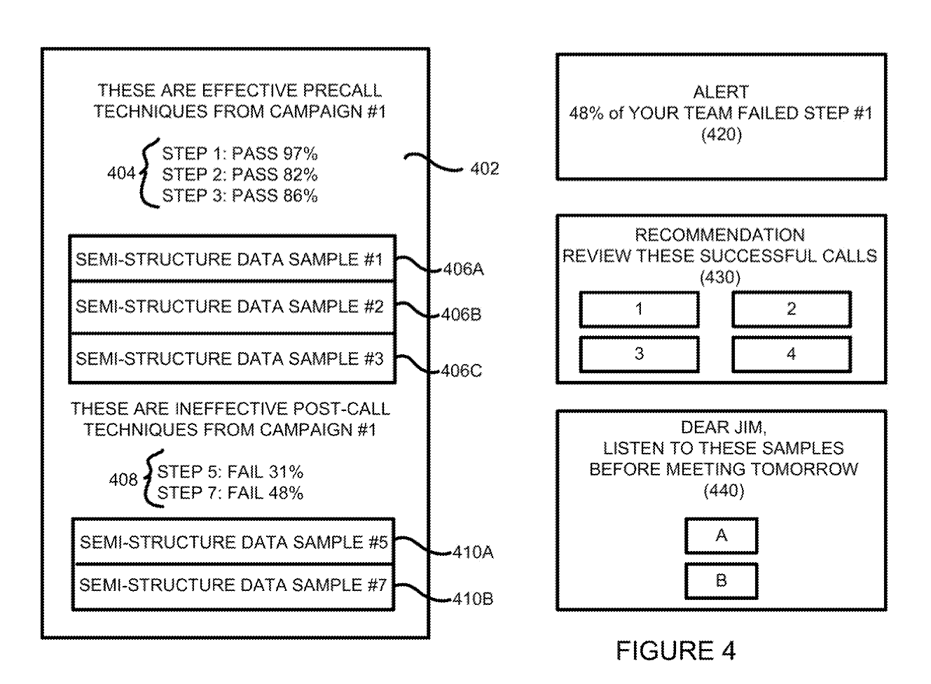

FIG. 4 shows, in accordance with an embodiment of the invention, some examples of auto-coaching utilizing the normalized structured data and/or value-added data. As mentioned earlier, individual chunks of the raw sales session recording, representing individual recorded portions of the sales session, that are associated with specific metadata tags may be automatically extracted, categorized, and graded for compliance with some predefined grading criteria. The extraction may be done automatically using speech or text analytics software and grading may subsequently be performed automatically on the extracted chunks.

Block 402 shows an automatic coaching feedback output, which is based on the grades accorded the extracted data chunks from the raw recording. By way of example, the extracted data chunks associated with metadata tags for step 1, step 2, and step 3 of the pre-call methodology may be graded for compliance with predefined grading criteria for step 1, step 2, and step 3. If the field salesperson fails to provide information regarding projected customer needs in pre-call step 2, for example, the grade given to the extracted recording portion corresponding to step 2 may be a failing grade.

In the example of FIG. 4, however, all 3 steps of the pre-call methodology pass their respective grading criteria and feedback is provided via block 402, which may be communicated to the team. Note that in addition to the grades (404), the extracted recording portions may be made accessible via hyperlinks (406A, 406B, and 406C) to permit stakeholders, including the field sales persons, to review to learn what was been done correctly.

In contrast, the extracted data chunks associated with metadata tags for step 5 and step 7 of the post-call methodology have been graded for compliance with their respective pre-defined grading criteria for post-call step 5 and step 7. In this example, the grades show that the field salespeople have failed to satisfactorily perform step 5 and step 7 of the post-call methodology. This information, which is automatically generated, may be presented to the stakeholders substantially in real time if desired. Furthermore, in addition to the failing grades (408), the extracted recording portions may be made accessible via hyperlinks (410A and 410B) to permit stakeholders, including the field salespersons, to review to learn what was done incorrectly.

In addition to giving automatic coaching feedback (402), alert may also be automatically generated for one or more sales teams. For example, the recorded data chunks corresponding to specific metadata may be analyzed in real-time as the recording data is streamed to the CHI portal or may be analyzed after the sales session is completed and the entire semi-structured data file is uploaded to the CHI server to detect which sales team is risking failure by their failure to adhere to the sales methodology promulgated by the company for a particular step (which results in a failing grade for that step).

The alert can be performed on a single data stream/file for a single sales team or may be performed on multiple data streams/files for multiple sales teams. In block 420, the alert was performed for multiple sales teams under the management of a given sales manager and the alert points out that multiple sales teams under the supervision of that sales manager failed Step 1 of the Pre-call sales methodology.

Further, auto-recommendations may be generated and provided to the field sales team to improve sales performance. Block 430 shows four recommendations, implemented via hyperlinks, that allow a field salesperson reviewing the information provided in block 430 to access recording portions from past sales sessions in which some other sales team successfully executed step 1 of the pre-call sales methodology.

In implementing auto-recommendations, the CHI portal may search for semi-structured data chunks or chunks of raw recordings from past sales campaign that are associated with the same general sales environment and/or the same type of metadata (e.g., industrial machine sales, pre-call step 41) and that have been deemed successfully executed in the past (e.g., having been assigned high passing grades by the automatic grading process or have been pre-selected by a human being as worthy examples of successfully executed sales methodology steps). The recommendations automatically selected may then be presented to the stakeholders (for example the field sales team) to facilitate sales coaching.

A stakeholder may also manually create a coaching message (440), which may be transmitted to another stakeholder (such as a sales team member) incorporating hyperlinks to samples of successful or unsuccessful sales technique/step in the current or past campaigns.

In accordance with an aspect of the invention, the coaching performed by sales coach may also be recorded for further review by supervisory coaches. Thus the supervisory coach may call up the coaching advices provided and/or resources provided as part of a coaching session, call up the chunk of raw recording data that was coached, and provide feedback to the previous coach about the effectiveness of the earlier coaching.

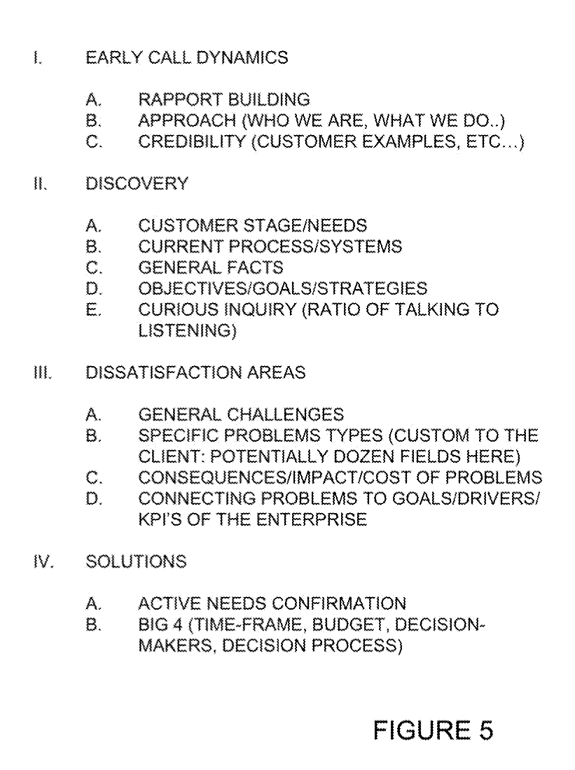

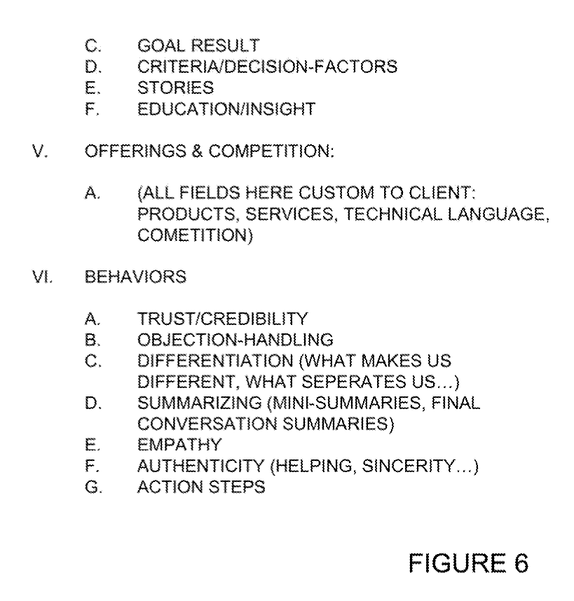

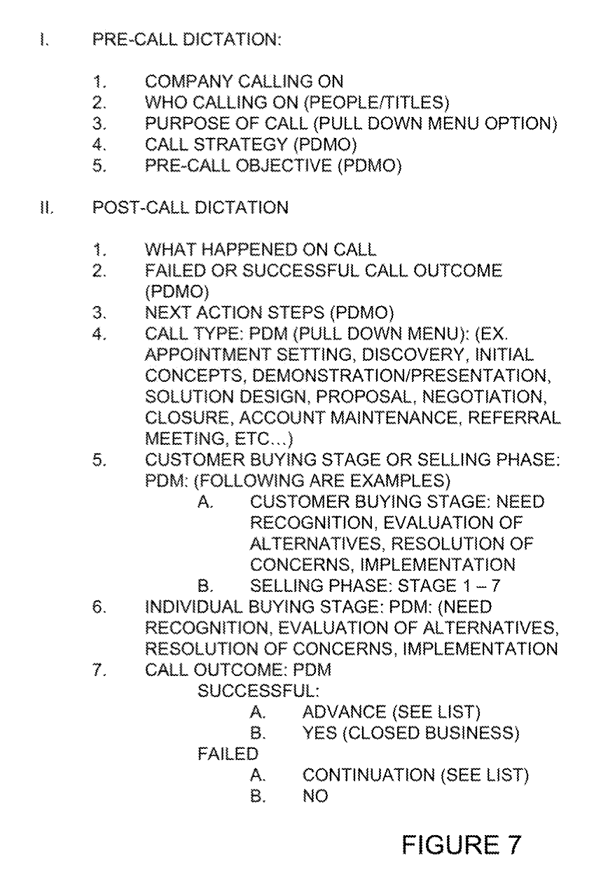

FIGS. 5 and 6 are examples, in accordance with embodiments of the invention, of categories and sub-categories employed to process the raw recorded data. The categorization may be employed as metadata tags, which facilitates extracting relevant chunks from the raw record data file and facilitates further analysis including, for example, searching, indexing, auto-grading, auto-coaching, sales productivity auditing, sales analysis, and the like. FIG. 7 shows, in accordance with an embodiment of the invention, some example metadata for pre-call and post-call. The data associated these metadata may be collected prior to the sales session via dictation, pull-down menus, inference (such as GPS coordinates or electronic calendar data), or imported from CRM business software, for example.

While this invention has been described in terms of several preferred embodiments, there are alterations, permutations, and equivalents, which fall within the scope of this invention. If the term “set” is employed herein, such term is intended to have its commonly understood mathematical meaning to cover zero, one, or more than one member. It should also be noted that there are many alternative ways of implementing the methods and apparatuses of the present invention. Although various examples are provided herein, it is intended that these examples be illustrative and not limiting with respect to the invention.

What is claimed is:

1. A method for processing complex human interaction (CHI) data using at least a computer executing computer readable instructions for performing at least a portion of said processing, comprising:
capturing, using a portable digital electronic device, unstructured session data pertaining to said CHI, said CHI pertaining to an interaction session between a first set of human stakeholders and a second set of human stakeholders;
annotating, using at least one of said portable digital electronic device and said computer, said unstructured session data with a set of metadata, thereby forming semi-structured data;
automatically normalizing, using said at least one of said portable digital electronic device and said computer, said semi-structured data to form normalized data, whereby said normalizing includes at least one of categorizing, sorting, automatic annotating, transcribing, concatenating, converting, and optical character recognition.

2. The method of claim I wherein said portable digital electronic device represents a smart pen for simultaneously capture hand-written data and audio data.

3. The method of claim 1 wherein said portable digital electronic device represents a smart phone.

4. The method of claim I wherein said portable digital electronic device represents a computer in tablet form.

5. The method of claim 1 wherein said annotating is performed automatically by electronic circuitry in said portable digital electronic device.

6. The method of claim 5 wherein said annotating employs automated handwriting analytic on said unstructured session data to derive said metadata.

7. The method of claim 5 wherein said annotating employs automated speech analytic on said unstructured session data to derive said metadata.

8. The method of claim 1 wherein said annotating is performed by one of said first set of human stakeholders via said at least one of said portable digital electronic device and said computer.

9. The method of claim 1 further comprising performing value-added processing on at least one of said semi-structured data and said normalized data.

10. The method of claim 9 wherein said value-added processing includes at least one of searching, analyzing, sharing, coaching using normalized structured data, indexing, annotating using speech/text analysis software, applying methodology, and applying framework.

11. The method of claim 1 further comprising automatically grading, said at least one of said portable digital electronic device and said computer, said semi-structured data against a predefined set of criteria, thereby deriving a set of grades.

12. The method of claim 11 further comprising generating, using at least said set of grades, at least one of feedback data and coaching data.

13. The method of claim 12 further comprising electronically communicating said at least one of said feedback data and said coaching data to at least a human stakeholder in said first set of human stakeholders.

14. The method of claim 1 wherein said unstructured session data includes at least audio data.

15. The method of claim 1 wherein said unstructured session data includes at least hand-written data that is created by a human stakeholder in said first set of human stakeholders.

16. A method for processing human sales session data using at least a computer executing computer readable instructions for performing at least a portion of said processing, comprising:
capturing, using a portable digital electronic device, unstructured session data pertaining to said human sales session, said human sales session pertaining to an interaction session between a first set of human stakeholders and a second set of human stakeholders;
annotating, using at least one of said portable digital electronic device and said computer, said unstructured session data with a set of metadata, thereby forming semi-structured data;
automatically normalizing, using said at least one of said portable digital electronic device and said computer, said semi-structured data to form normalized data, whereby said normalizing includes at least one of categorizing, sorting, automatic annotating, transcribing, concatenating, converting, and optical character recognition.

17. The method of claim 16 wherein said portable digital electronic device represents a smart pen for simultaneously capture hand-written data and audio data.

18. The method of claim 16 wherein said portable digital electronic device represents a smart phone.

19. The method of claim 16 wherein said portable digital electronic device represents a computer in tablet form.

20. The method of claim 16 wherein said annotating is performed automatically by electronic circuitry in said portable digital electronic device.

21. The method of claim 20 wherein said annotating employs automated handwriting analytic on said unstructured session data to derive said metadata.

22. The method of claim 20 wherein said annotating employs automated speech analytic on said unstructured session data to derive said metadata.

23. The method of claim 20 wherein said annotating is performed by one of said first set of human stakeholders via said at least one of said portable digital electronic device and said computer.

24. The method of claim 16 further comprising performing value-added processing on at least one of said semi-structured data and said normalized data.

25. The method of claim 24 wherein said value-added processing includes at least one of searching, analyzing, sharing, coaching using normalized structured data, indexing, annotating using speech/text analysis software, applying methodology, and applying framework.

26. The method of claim 16 further comprising automatically grading, said at least one of said portable digital electronic device and said computer, said semi-structured data against a predefined set of criteria, thereby deriving a set of grades.

27. The method of claim 26 further comprising generating, using at least said set of grades, at least one of feedback data and coaching data.

28. The method of claim 27 further comprising electronically communicating said at least one of said feedback data and said coaching data to at least a human stakeholder in said first set of human stakeholders.

29. The method of claim 16 wherein said unstructured session data includes at least audio data.

30. The method of claim 16 wherein said unstructured session data includes at least hand-written data that is created by a human stakeholder in said first set of human stakeholders.

31. Apparatus for processing complex human interaction (CHI) data between a first set of human stakeholders and a second set of human stakeholders, comprising:
at least a database for storing at least unstructured session data pertaining to said CHI, said CHI pertaining to an interaction session between said first set of human stakeholders and said second set of human stakeholders;
at least a computer executing computer readable instructions for performing at least automatically annotating said unstructured session data with a set of metadata, thereby forming semi-structured data and automatically normalizing said semi-structured data to form normalized data, whereby said normalizing includes at least one of categorizing, sorting, automatic annotating, transcribing, concatenating, converting, and optical character recognition.

32. The apparatus of claim 31 wherein said unstructured session data represents data uploaded from a smart phone.

33. The apparatus of claim 31 wherein said unstructured session data represents data uploaded from a computer in tablet form.

34. The apparatus of claim 31 wherein said annotating includes automated handwriting analytic on said unstructured session data to derive said metadata.

35. The apparatus of claim 31 wherein said annotating includes automated speech analytic on said unstructured session data to derive said metadata.

36. The apparatus of claim 31 wherein said computer further includes computer readable instructions for performing value-added processing on at least one of said semi-structured data and said normalized data.

37. The apparatus of claim 36 wherein said value-added processing includes at least one of searching, analyzing, sharing, coaching using normalized structured data, indexing, annotating using speech/text analysis software, applying methodology, and applying framework.

38. The apparatus of claim 31 wherein said computer further includes computer readable instruction for automatically grading said semi-structured data against a predefined set of criteria, thereby deriving a set of grades.

39. The apparatus of claim 38 wherein said computer further includes computer readable instruction for generating, using at least said set of grades, at least one of feedback data and coaching data.
